(19) United States
(12) Patent Application Publication
(10) Pub. No.: US 2024/0267809 A1
(43) Pub. Date: Aug. 8, 2024

(54) PROCEDURE OF CELL CHANGE IN A RADIO SYSTEM

(71) Applicant: MediaTek Singapore Pte. Ltd., Singapore (SG)

(72) Inventors: Miao Wang, Beijing (CN); Tsang-Wei Yu, Hsinchu City (TW)

(21) Appl. No.: 18/436,925

(22) Filed: Feb. 8, 2024

Related U.S. Application Data
(63) Continuation of application No. PCT/CN2023/075040, filed on Feb. 8, 2023.

(30) Foreign Application Priority Data
Feb. 8, 2023 (WO) PCT/CN2023/075040
Jan. 24, 2024 (CN) CN 202410102729.3

(51) Int. Cl. H04W 36/08; H04W 36/00; H04W 56/00

(52) U.S. Cl. CPC H04W 36/08; H04W 36/0038; H04W 36/0072; H04W 56/0015

(57) ABSTRACT

Apparatus and methods are provided for enhanced cell change procedure. In one novel aspect, downlink synchronization on the target cell is performed before performing one or more UE L1/L2/L3 processing procedures. In one embodiment, the command for cell change is a cell switch command. In one embodiment, the cell switch command is carried by a MAC control element (CE). In one embodiment, the command for cell change is a conditional handover command, and wherein the UE performs downlink synchronization on the target cell when at least one handover condition is met. In one embodiment, the cell switch procedure is a random access channel (RACH) based cell switch. In another embodiment, the cell switch procedure is a RACH-less cell switch procedure.

### CROSS REFERENCE TO RELATED APPLICATIONS

This application is filed under 35 U.S.C. § 111 (a) and is based on and hereby claims priority under 35 U.S.C. § 120 and § 365 (c) from International Application No. PCT/CN2023/075040, titled “PROCEDURE OF CELL CHANGE IN A RADIO SYSTEM,” with an international filing date of Feb. 8, 2023. This application claims priority under 35 U.S.C. § 119 from Chinese Application Number 202410102729.3, titled “PROCEDURE OF CELL CHANGE IN A RADIO SYSTEM,” filed on Jan. 24, 2024. The disclosure of each of the foregoing documents is incorporated herein by reference.

### TECHNICAL FIELD

The disclosed embodiments relate generally to wireless communication, and, more particularly, to cell change procedure.

### BACKGROUND

Mobility performance is a very important metric in a wireless communication system. Researchers are working hard on reducing handover delay and interruption. The shorter the delay and interruption are, the less data would be lost. To reduce handover delay, L1/L2 triggered mobility is designed. In L1/L2 triggered mobility, through pre-synchronization of downlink on the target cell, cell switch delay and data interruption time can be reduced. In the current procedure, after receiving handover command or cell switch command, UE L1/L2/L3 processing is performed at first, including L2/L3 reconfiguration, RF retuning, baseband retuning, security update if needed, etc. And then UE would perform downlink synchronization on the target cell if needed. And then uplink synchronization on the target cell if needed. The interruption starts from UE L1/L2/L3 processing. Although for L1/L2 triggered mobility, UE would perform pre-synchronization of downlink on the target cell, UE may still need to perform downlink synchronization on the target cell before data reception due to UE mobility and channel condition change. The data interruption starts when UE performs L1/L2/L3 processing. The data interruption time includes the time waiting for reference signal for downlink synchronization.

Improvements and enhancements are required for cell change procedures.

### SUMMARY

Apparatus and methods are provided for enhanced cell change procedure. In one novel aspect, downlink synchronization on the target cell is performed before performing one or more of UE L1/L2/L3 processing procedures. In one embodiment, the UE receives a command for cell change from the wireless network, wherein the command for cell change indicates to switch from a source cell to a target cell, performs downlink synchronization on the target cell before performing one or more of UE layer-1/layer-2/layer-3 (L1/L2/L3) processing procedures, wherein the UE L1/L2/L3 processing procedures comprising L2 reconfiguration, L3 reconfiguration, radio frequency (RF) retuning, baseband retuning and security update, and performs a cell switch procedure to the target cell after performing the one or more UE L1/L2/L3 processing procedures. In one embodiment, the command for cell change is a cell switch command. In one embodiment, the UE receives a pre-configuration of candidate cells from the wireless network before receiving the cell switch command. In one embodiment, the UE performs downlink synchronization after receiving the cell switch command. In one embodiment, the cell switch command is carried by a MAC control element (CE). In one embodiment, the command for cell change is a conditional handover command, and wherein the UE performs downlink synchronization on the target cell when at least one handover condition is met. In one embodiment, the cell switch procedure is a random access channel (RACH) based cell switch. In one embodiment, the UE transmits physical RACH (PRACH) on the target cell before performing the one or more of UE L1/L2/L3 processing procedures and after receiving the command for cell change. In another embodiment, the UE transmits the PRACH on the target cell after performing the one or more of UE L1/L2/L3 processing procedures. In another embodiment, the cell switch procedure is a RACH-less cell switch procedure.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a schematic system diagram illustrating an exemplary wireless network with enhanced cell change procedures in accordance with embodiments of the current invention.

FIG. 1B illustrates an exemplary UE and base station for enhanced change procedures in accordance with embodiments of the current invention.

FIG. 2 illustrates an exemplary wireless system with centralized upper layers of the NR radio interface stacks in accordance with embodiments of the current invention.

FIG. 3 illustrates an exemplary deployment scenario for intra-DU inter-cell beam management in accordance with embodiments of the current invention.

FIG. 4 illustrates an exemplary deployment scenario for inter-DU inter-cell beam management in accordance with embodiments of the current invention.

FIG. 5 illustrates an exemplary diagram of a RACH-based traditional cell change procedure.

FIG. 6 illustrates exemplary diagrams for enhanced RACH-based cell change procedure with RACH performed after the UE processing in accordance with embodiments of the current invention.

FIG. 7 illustrates exemplary diagrams for enhanced RACH-based cell change procedure with RACH performed before the UE processing in accordance with embodiments of the current invention.

FIG. 8 illustrates an exemplary of a RACH-less traditional cell change procedure.

FIG. 9 illustrates exemplary diagrams for enhanced RACH-less cell change procedure in accordance with embodiments of the current invention.

FIG. 10 illustrates an exemplary flow chart for the enhanced cell change procedure in accordance with embodiment of the current inventions.

### DETAILED DESCRIPTION

Reference will now be made in detail to some embodiments of the invention, examples of which are illustrated in the accompanying drawings.

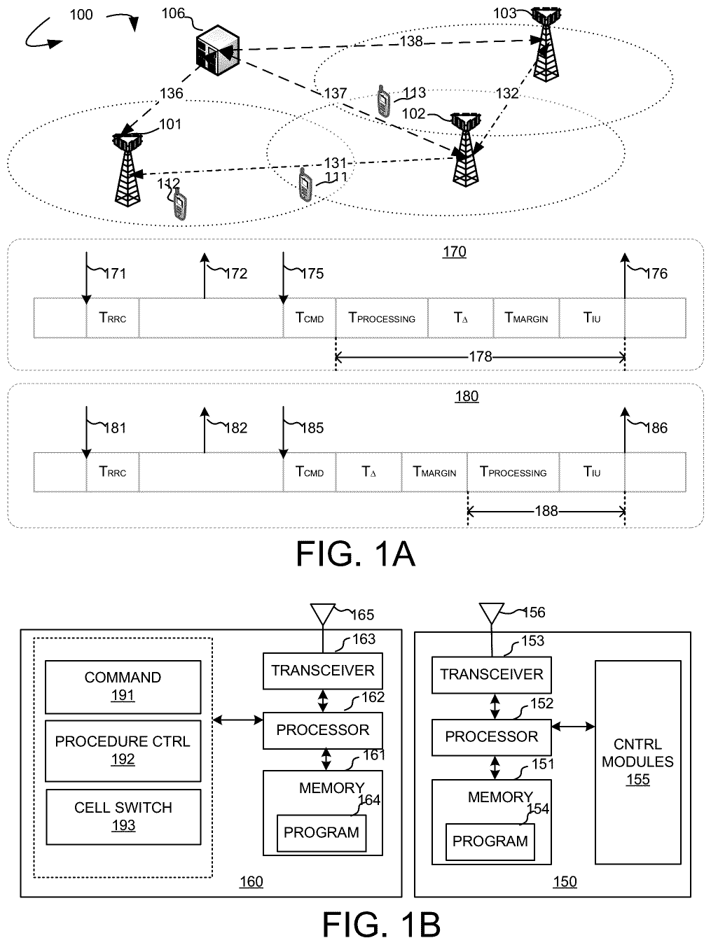

FIG. 1A is a schematic system diagram illustrating an exemplary wireless network with enhanced cell change procedures in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 in the overlapping service area of gNB 101 and gNB 102 and may switch back and forth between gNB 101 and gNB 102. UE 113 in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect the non-co-located receiving base units. Xn connection 131 connects gNB 101 and gNB 102. Xn connection 132 connects gNB 102 and gNB 103. These Xn/NG connections can be either ideal or non-ideal.

In one novel aspect, enhanced cell change procedure is performed with UE processing procedures performed after the downlink synchronization procedures. Diagram 170 shows an exemplary legacy cell change procedure. At step 171, the UE receives RRC pre-configuration message with candidate cells. The UE processes the RRC message with T_{RRC}, which is around 10 ms. At step 172, the UE sends L1 measurement report based on the pre-configuration message. At step 175, the UE receives cell switch command. The UE processes the cell switch command with a time of T_{cmd}, the typical value of which is around T_{HARQ}+3 ms, where T_{HARQ} is the time between cell switch command and acknowledgement to network of receiving the command. In the current system, upon receiving the cell switch command, the UE performs the UE processing procedures with T_{PROCESSING} Of about 20 ms. The interruption starts when the UE processing procedure starts. Further, although the UE may perform DL synchronization before cell switch command, including time frequency tracking (T/F tracking), the UE still needs to perform T/F tracking again after receiving the cell switch command, with T_{Δ}+T_{MARGIN}, where TA is around 20 ms and T_{MARGIN} is around 2 ms. An UL synchronization is performed with T_{IU} for about 15 ms before RACH is performed at step 176. For the exemplary legacy cell change procedure, the interruption time 178 is the sum of T_{PROCESSING}, T_{Δ}+T_{MARGIN}, and T_{IU}.

In one novel aspect, the downlink synchronization is performed before the UE processing procedures to reduce the interruption time. Diagram 180 illustrates an exemplary timeline for the enhanced cell change procedure. At step 181, the UE receives RRC pre-configuration message with candidate cells. The UE processes the RRC message with T_{RRC}, which is around 10 ms. At step 182, the UE sends L1 measurement report based on the pre-configuration message. At step 185, the UE receives cell switch command. The UE process the cell switch command with a time of T_{CMD}, which is around 3 ms. After receiving the cell switch command, the UE first performs the DL synchronization procedure, including T/F tracking with T_{Δ}+T_{MARGIN}. Subsequently, the interruption starts when the UE processing procedure starts. An UL synchronization is performed with T_{IU} for about 15 ms before RACH is performed at step 186. For the exemplary enhanced cell change procedure, the interruption time 188 is the sum of T_{PROCESSING}, and T_{IU}.

FIG. 1B illustrates an exemplary UE and base station for enhanced cell change procedures in accordance with embodiments of the current invention. Diagram 150 is an exemplary simplified block diagram of a base station/gNB. The base station has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in the base station. Memory 151 stores program instructions and data 154 to control the operations of the base station. The base station also includes a set of control modules 155 that carry out functional tasks to communicate with mobile stations.

Diagram 160 illustrates simplified block diagrams of a mobile device/UE for enhanced cell change procedure. The UE has antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands transmitting and receiving. RF transceiver 163 also converts received baseband signals from processor 162, converts them to RF signals, and sends out to antenna 165. Processor 162 processes the received baseband signals and invokes different functional modules to perform features in the UE. Memory 161 stores program instructions and data 164 to control the operations of the UE. Antenna 165 sends uplink transmission and receives downlink transmissions to/from the base station.

The UE also includes a set of control modules that carry out functional tasks. These control modules can be implemented by circuits, software, firmware, or a combination of them. A command module 191 receives a command for cell change from the wireless network, wherein the command for cell change indicates to switch from a source cell to a target cell. A procedure controller 192 performs downlink synchronization on the target cell and subsequently, performs one or more of UE L1/L2/L3 processing procedures, wherein the UE L1/L2/L3 processing procedures comprising L2 reconfiguration, L3 reconfiguration, radio frequency (RF) retuning, baseband retuning and security update. A cell switch module 193 switches the UE to the target cell after performing the one or more of UE L1/L2/L3 processing procedures.

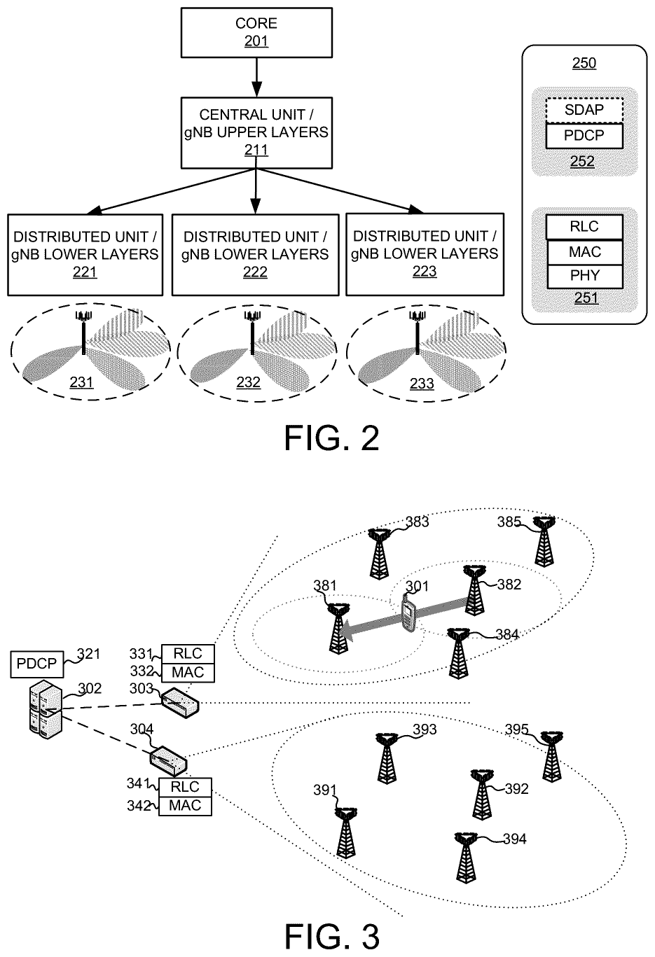

FIG. 2 illustrates an exemplary NR wireless system with centralized upper layers of the NR radio interface protocol stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each correspond to a cell 231, 232, and 233, respectively. The DUs, such as 221, 222 and 223 include gNB lower layers 251. In one embodiment 250, gNB lower layers 251 include the PHY, MAC and the RLC layers.

FIG. 3 illustrates an exemplary deployment scenario for intra-DU inter-cell beam management in accordance with embodiments of the current invention. A CU 302 is connected to two DUs 303 and 304 through the F1 interface. CU 302 includes protocol stack PDCP 321. DU 303 includes protocol stack RLC 331 and MAC 332. DU 304 includes protocol stack RLC 341 and MAC 342. DU 303 and DU 304 are connected to multiple radio units (RUs) respectively. A cell may consist of a range covered by one or more RUs under the same DU. RUs/gNBs 381, 382, 383, 384, and 385 are connected with DU 303. RUs/gNBs 391, 392, 393, 394, and 395 are connected with DU 304. In this scenario, a UE 301 is moving from the edge of one cell served by gNB 382 to another cell served by gNB 381, which two belong to the same DU and share a common protocol stack. Intra-DU inter-cell beam management can be used in this scenario to replace the legacy handover process to reduce the interruption and improve the throughput and handover reliability in terms of handover failure rate of UE. In one embodiment, single protocol stack at the UE side (common RLC/MAC) is used to handle L1/L2 inter-cell beam management with mobility.

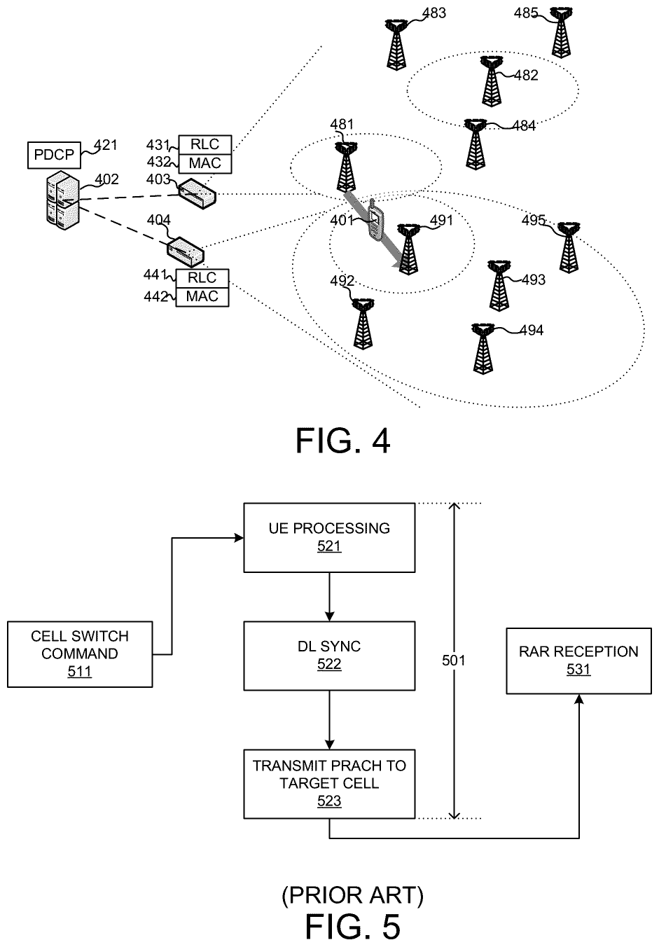

FIG. 4 illustrates an exemplary deployment scenario for inter-DU inter-cell beam management in accordance with embodiments of the current invention. A CU 402 is connected to two DUs, DU 403 and DU 404 through the F1 interface, respectively. CU 402 includes protocol stack PDCP 421. DU 403 includes protocol stack RLC 431 and MAC 432. DU 404 includes protocol stack RLC 441 and MAC 442. DU 403 and DU 404 are connected to multiple RUs respectively. A cell may consist of a range covered by one or more RUs under the same DU. RUs/gNBs 481, 482, 483, 484, and 485 are connected with DU 403. RUs/gNBs 491, 492, 493, 494, and 495 are connected with DU 404. In this scenario, a UE 401 is moving from the edge of one cell served by gNB 481 to another cell served by gNB 491, which belong to different DUs, DU 403 and DU 404, respectively, and share a common CU 402. The low layer user plane (RLC, MAC) is different in two DUs while high layer (PDCP) remains the same. Inter-DU inter-cell beam management can be used in this scenario to replace the legacy handover process to reduce the interruption and improve the throughput and handover reliability in terms of handover failure rate of UE. In one embodiment, single protocol stack at the UE side (common RLC/MAC) is used to handle L1/L2 inter-cell beam management with mobility. In one embodiment, dual protocol stack at the UE side (separate RLC/MAC) are used to handle L1/L2 inter-cell beam management with mobility.

FIG. 5 illustrates an exemplary diagram of a RACH-based traditional cell change procedure. At step 511, the UE receives cell change command. After performing some necessary processing on decoding the command, at step 521 the UE performs one or more L1/L2/L3 processing procedures, including L2 and/or L3 reconfiguration, and/or RF retuning, and/or baseband retuning, and/or security update, etc. At step 522, the UE performs downlink synchronization on the target cell. Then transmits PRACH to the target cell if needed. The interruption time starts from step 521 when the UE performs one or more L1/L2/L3 processing procedures and ends at step 523 when the UE transmits PRACH to the target cell. At step 531 the UE receives random access response (RAR). As illustrated, the legacy cell change procedure has a long interruption time 501 including the UE processing time, the DL synchronization time and the PRACH transmission time.

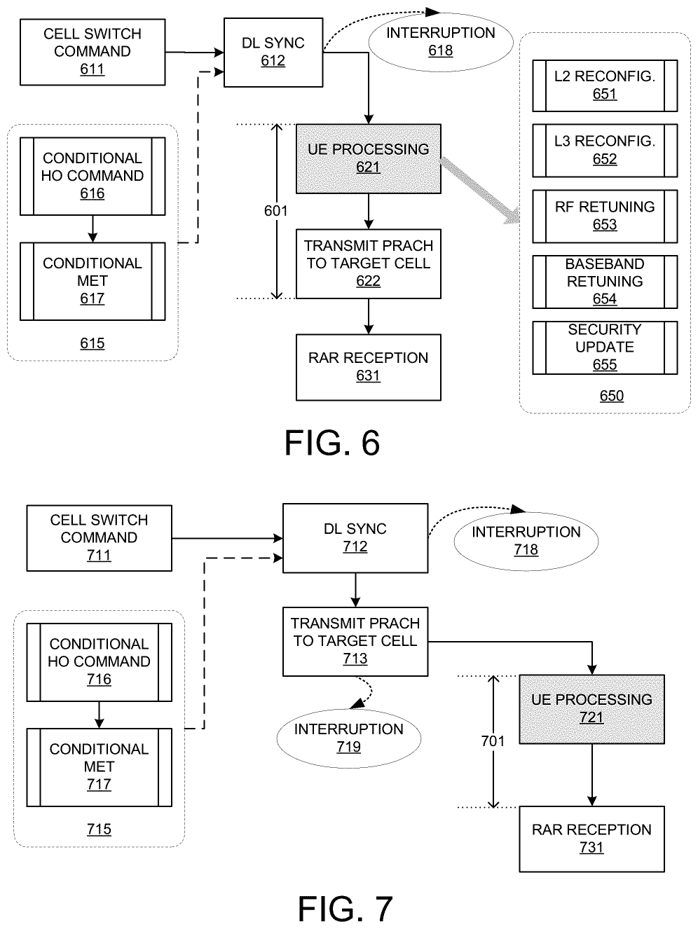

FIG. 6 illustrates exemplary diagrams for enhanced RACH-based cell change procedure with RACH performed after the UE processing in accordance with embodiments of the current invention. The UE receives command for cell change. In one embodiment 611, the command for cell change is the cell switch command. In one embodiment, the cell switch command is received by MAC control element (CE). In another embodiment 615, the UE receives a conditional handover (HO) command at step 616. At step 617, at least one condition is met. The command for cell change is triggered at step 617 when at least one condition is met. At step 612, after some necessary processing on decoding the command or detecting the condition, the UE performs downlink synchronization on the target cell first. The interruption time does not start when the DL synchronization procedure starts. An interruption 618 may occur when receiving reference signal (RS) for DL synchronization. At step 621, the UE performs one or more of L1/L2/L3 processing procedures. The L1/L2/L3 processing procedures 650 include L2 reconfiguration 651, and/or L3 reconfiguration 652, and/or RF retuning 653, and/or baseband retuning 654, and/or security update 655, and etc. At step 622, the UE transmits PRACH to the target cell if needed. The interruption time 601 starts from step 621 when UE performs one or more of L1/L2/L3 processing procedures and ends at step 622 when UE transmits PRACH to the target cell.

FIG. 7 illustrates exemplary diagrams for enhanced RACH-based cell change procedure with RACH performed before the UE processing in accordance with embodiments of the current invention. The UE receives command for cell change. In one embodiment 711, the command for cell change is the cell switch command. In one embodiment, the cell switch command is received by MAC control element (CE). In another embodiment 715, the UE receives a conditional handover (HO) command at step 716.

At step 717, at least one condition is met. The command for cell change is triggered at step 717 when at least one condition is met. At step 712, after some necessary processing on decoding the command or detecting the condition, the UE performs downlink synchronization on the target cell at first. An interruption 718 may occur when receiving reference signal (RS) for DL synchronization. At step 713, the UE transmits PRACH to the target cell if needed. An interruption 719 may occur due to the transmission of the PRACH. At step 721, the UE performs one or more of L1/L2/L3 processing procedures, and the L1/L2/L3 processing procedures comprising the L2 reconfiguration, the L3 reconfiguration, the RF retuning, the baseband retuning, the security update, and etc. The interruption time 701 starts from step 721 when the UE performs one or more of L1/L2/L3 processing procedures and ends at step 731 when the UE completes L1/L2/L3 processing and starts to receive RAR.

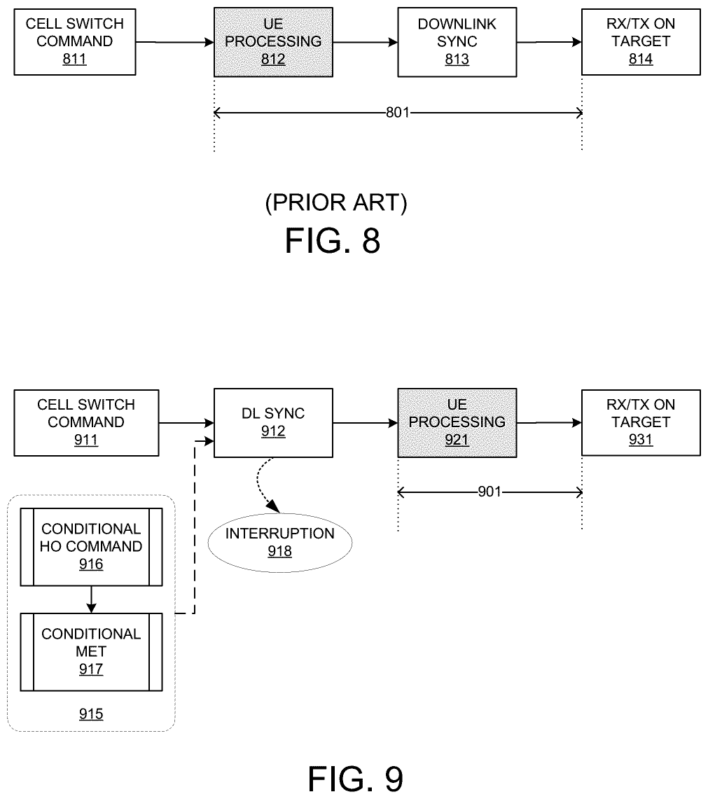

FIG. 8 illustrates an exemplary of a RACH-less traditional cell change procedure. At step 811, the UE receives cell change command. After some necessary processing on decoding the command, at step 812, the UE performs one or more of L1/L2/L3 processing procedures, including one or more procedures of the L2 reconfiguration, the L3 reconfiguration, the RF retuning, the baseband retuning, the security update, and etc. At step 813, the UE performs downlink synchronization on the target cell. The interruption time 801 starts from step 812 when the UE performs one or more of L1/L2/L3 processing procedures and ends at step 813 when the UE completes DL synchronization on the target cell and starts transceiving on the target cell. At step 814, the UE starts transceiving on the target cell.

FIG. 9 illustrates exemplary diagrams for enhanced RACH-less cell change procedure in accordance with embodiments of the current invention. The UE receives command for cell change. In one embodiment 911, the command for cell change is the cell switch command. In one embodiment, the cell switch command is received by MAC control element (CE). In another embodiment 915, the UE receives a conditional handover (HO) command at step 916. At step 917, at least one condition is met. The command for cell change is triggered at step 917 when at least one condition is met. At step 912, after some necessary processing on decoding the command, the UE performs downlink synchronization on the target cell first. At step 921, the UE performs one or more of L1/L2/L3 processing procedures, including one or more procedures of the L2 reconfiguration, the L3 reconfiguration, the RF retuning, the baseband retuning, the security update, and etc. The interruption time 901 starts from step 912 when the UE performs one or more of L1/L2/L3 processing procedures and ends when the UE completes the UE processing and starts transceiving on the target cell. There may be also some interruption 918 at step 912 due to reference signal reception for DL synchronization on the target cell.

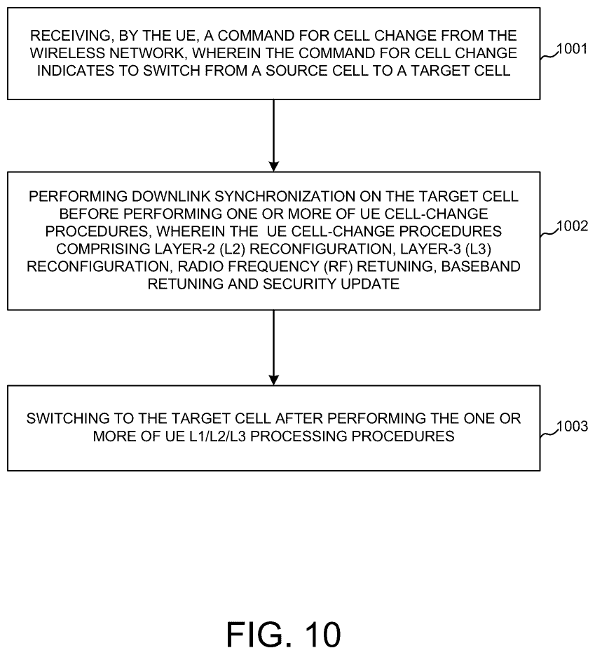

FIG. 10 illustrates an exemplary flow chart for the enhanced cell change procedure in accordance with embodiment of the current inventions. At step 1001, the UE receives a command for cell change from the wireless network, wherein the command for cell change indicates to switch from a source cell to a target cell. At step 1002, the UE performs downlink synchronization on the target cell before performing one or more of UE layer-1/layer-2/layer-3 (L1/L2/L3) processing procedures, wherein the UE L1/L2/L3 processing procedures comprising L2 reconfiguration, L3 reconfiguration, radio frequency (RF) retuning, baseband retuning and security update. At step 1003, the UE switches to the target cell after performing the one or more of UE L1/L2/L3 processing procedures.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) in a wireless network, comprising:
receiving, by the UE, a command for cell change from the wireless network, wherein the command for cell change indicates to switch from a source cell to a target cell;
performing downlink synchronization on the target cell before performing one or more of UE layer-1/layer-2/layer-3 (L1/L2/L3) processing procedures, wherein the UE L1/L2/L3 processing procedures comprising L2 reconfiguration, L3 reconfiguration, radio frequency (RF) retuning, baseband retuning and security update; and
switching to the target cell after performing the one or more of UE L1/L2/L3 processing procedures.

2. The method of claim 1, wherein the command for cell change is a cell switch command.

3. The method of claim 2, wherein the UE receives a pre-configuration of candidate cells from the wireless network before receiving the cell switch command.

4. The method of claim 2, wherein the UE performs downlink synchronization after receiving the cell switch command.

5. The method of claim 2, wherein the cell switch command is carried by a MAC control element (CE).

6. The method of claim 1, wherein the command for cell change is a conditional handover command, and wherein the UE performs downlink synchronization on the target cell when at least one handover condition is met.

7. The method of claim 1, wherein the cell switch procedure is a random access channel (RACH) based cell switch.

8. The method of claim 7, wherein the UE transmits physical RACH (PRACH) on the target cell before performing the one or more of UE L1/L2/L3 processing procedures and after receiving the command for cell change.

9. The method of claim 7, wherein the UE transmits PRACH on the target cell after performing the one or more of UE L1/L2/L3 processing procedures.

10. The method of claim 1, wherein the cell switch procedure is a RACH-less cell switch procedure.

11. A user equipment (UE), comprising:
a transceiver that transmits and receives radio frequency (RF) signal in a wireless network;
a command module that receives a command for cell change from the wireless network, wherein the command for cell change indicates to switch from a source cell to a target cell;
a procedure controller that performs downlink synchronization on the target cell before performing one or more of UE layer-1/layer-2/layer-3 (L1/L2/L3) processing procedures, wherein the UE L1/L2/L3 processing procedures comprising L2 reconfiguration, L3 reconfiguration, radio frequency (RF) retuning, baseband retuning and security update; and
a cell switch module that switches the UE to the target cell after performing the one or more UE L1/L2/L3 processing procedures.

12. The UE of claim 11, wherein the command for cell change is a cell switch command.

13. The UE of claim 12, wherein the UE receives a pre-configuration of candidate cells from the wireless network before receiving the cell switch command.

14. The UE of claim 12, wherein the UE performs downlink synchronization after receiving the cell switch command.

15. The UE of claim 12, wherein the cell switch command is carried by a MAC control element (CE).

16. The UE of claim 11, wherein the command for cell change is a conditional handover command, and wherein the UE performs downlink synchronization on the target cell when at least one handover condition is met.

17. The UE of claim 11, wherein the cell switch procedure is a random access channel (RACH) based cell switch.

18. The UE of claim 17, wherein the UE transmits physical RACH (PRACH) on the target cell before performing the one or more of UE L1/L2/L3 processing procedures and after receiving the command for cell change.

19. The UE of claim 17, wherein the UE transmits PRACH on the target cell after performing the one or more of UE L1/L2/L3 processing procedures

20. The UE of claim 11, wherein the cell switch procedure is a RACH-less cell switch procedure.
